(19) United States
(12) Patent Application Publication
(10) Pub. No.: US 2007/0128382 A1
(43) Pub. Date: Jun. 7, 2007

(54) Elliptically polarizing plate and method of producing the same

(75) Inventors: Hideki Hayashi, Nishitokyo-shi (JP); Yoshiki Matsuoka, Niihama-shi (JP)

Correspondence Address: SUGHRUE MION, PLLC, 2100 PENNSYLVANIA AVENUE, N.W., SUITE 800, WASHINGTON, DC, 20037, US

(73) Assignee: SUMITOMO CHEMICAL COMPANY, LIMITED

(21) Appl. No.: 11/603,153

(22) Filed: Nov. 22, 2006

(30) Foreign Application Priority Data
Dec. 2, 2005 (JP) 2005-348966

(51) Int. Cl. C09K 19/00

(52) U.S. Cl. 428/1.31

(57) ABSTRACT

A rolled elliptically polarizing plate that is made by laminating a compensation film 13 having a coated layer made by a coating agent performing a compensation function on the surface of a rolled linear polarizing plate, the compensation film being a rolled film formed by application of a coating agent performing a compensation function to the surface of a transparent substrate, the linear polarizing plate and the compensation film being laminated by means of roll to roll processing by making the respective longitudinal directions approximately in parallel, or the above compensation film being formed by application of a coating agent performing a compensation function to the surface of the rolled linear polarizing plate.

### BACKGROUND OF THE INVENTION

1. Field of the Invention

The present invention relates to an elliptically polarizing plate used for a display apparatus such as a liquid crystal display, organic electric light-emitting display, which is good in production efficiency and yield, and is suitable for reducing thickness of devices. And the present invention also relates to a method of producing the same. The invention further relates to a display apparatus such as a liquid crystal display, organic electric light-emitting display, touch panel, or the like, with using the elliptical polarizing plate.

2. Background of the Invention

An elliptically polarizing plate used for a display apparatus such as a liquid crystal display is generally constructed by laminating a linear polarizing plate and a compensation film. In other words, a linear polarizing plate and a compensation film are laminated by means of an adhesive or the like so that the absorption axis the linear polarizing plate and the retardation axis of the compensation film are at a specific angle.

Recently, liquid crystal display is widely available not only to monitors and note type personal computers, but also to small electronic instruments such as navigation systems for automobiles, cellular phones and personal digital assistance (PDA), and large electronic instruments such as televisions. With such spread, the demands of markets for downsizing instruments and reducing thickness of devices are increased every year. Accompanying these demands are stronger requests for reducing the thickness of elliptically polarizing plates more than conventional elliptically polarizing plates. In addition, reducing the thickness of the plate is advantageous from the viewpoint of improved flexibility.

Based on such a background, some methods for reducing the thickness of polarizing plates are proposed so far. For example, one of the methods is to reduce the thickness of a protective film used in a polarizer. Moreover, in JP2001-108830A, a protective film of a polarizer is laminated only on one surface of a polarizing plate, and a laminated model having a retardation film laminated on the other surface by means of a sticker; a protective film on one surface of the polarizing plate is omitted to achieve the reduction of the thickness of the polarizing plate.

On the other hand, demands for making the prices lower from the market also are increased every year. As such, when an elliptical polarizing plate is produced, there are some demands such as continuation process of the lamination step, improvement of yield, reduction of material loss, and the like.

When an elliptical polarizing plate is produced, at present, the common methods include a method that involves laminating a linear polarizing plate and a compensation film, both of which are laminated in the form of a sheet (so called sheet to sheet laminating processing) and a method in which one of linear polarizing plate and a compensation film is a rolled film and on this rolled film is laminated the other film in the form of sheet (so called sheet to roll laminating processing, or sometimes called roll to sheet laminating processing).

As a method of producing an elliptically polarizing plate via sheet to sheet laminating processing, JP4-123008A proposes a method that involves adjusting and adhering sheet materials of a linear polarizing plate and a compensation film so as to be positioned at a specific angle, cutting the edges of the resulting laminate to yield an elliptical polarizing plate. This method, however, needs to separately carry out each of the three processes of the process of cutting a linear polarizing plate, the process of cutting a compensation film, and the process of adhering the linear polarizing plate and the compensation film. In such method, the operating processes are complicated, the loss of materials during the operating process is great, and the cost tends to be increased. In addition, yield may not be advantageous, and the continuation of the laminating step may not be easy.

As a method of producing an elliptical polarizing plate by means of sheet to sheet laminating processing, JP10-206631A proposes a method that involves cutting either one of the long materials of a linear polarizing plate and a compensation film so as to be positioned at a specific angle relative to each optical axis to obtain a sheet material, and continuously laminating the sheet material to the other long material in such a way that each optical axis is positioned at a specific angle θ to produce an elliptical polarizing plate. However, this method involves laminating a sheet material of the optical films on the other rolled optical film by means of exact angle control. Thus, it is possible to some extent to carry out the continuation of the laminating step, the improvement of yield, and the reduction of loss of material, but the method may not increase production capacity. Moreover, the method has a limit to cost reduction.

As described above, when an elliptical polarizing plate is produced, a variety of investigations have been carried out on the methods of laminating a linear polarizing plate and a compensation film and producing the plate. However, a sufficient solution has not been found in either case from the viewpoints of continuation of the laminating step, improvement of yield, reduction of material loss, and cost reduction. This is because both a linear polarizing plate and a compensation film, used in the production of an elliptical polarizing plate, usually are stretched in the process, and thus in general the stretch direction is along the absorption axis in the linear polarizing plate and the stretch direction is along the slow axis in the compensation film, and when an elliptical polarizing plate is produced, the absorption axis of a linear polarizing plate and the slow axis of a compensation film need to be laminated neither in parallel nor in perpendicular to each other, and thus the method of laminating both of the rolled films in the longitudinal direction (so called roll to roll laminating processing) cannot be adopted.

In contrast to this, a method is also proposed that involves laminating a linear polarizing plate and a compensation material in the form of a long material (so called roll to roll laminating processing). For instance, JA6-289221A proposes a method that involves cutting a long, linear polarizing plate in the form of a bias such that the long, linear polarizing plate is positioned at a specific angle relative to the longitudinal direction (absorption direction), and then joining the bias cut plates such that the upper and lower cut sides are in parallel. However, this method needs the process of joining the bias cut plates, thereby not increasing production capacity, and lowering yield due to low precision of angle control when it is laminated with a compensation film, leading to a large increase in cost. Additionally, use of, for example, an adhesive tape on the site to be joined may cause problems in that the site is lost in a product, the joint generates a step height caused by the adhesive tape, producing a cause of the failure of joining the linear polarizing plate, and the like. Furthermore, even though a rolled elliptically polarizing plate is produced, the joint remains on the roll, and thus cutting out the elliptically polarizing plate without a joint is extremely difficult when a sheet-like elliptical polarizing plate with a large size is cut out.

JP6-300918A proposes a method of producing an elliptical polarizing plate that involves cutting either one of the long materials of a linear polarizing plate and a compensation film in such a way that each of two sides contacted by the rectangle has a specific angle relative to the stretch axis, to yield a rectangular material, and continuously immobilizing the rectangular material to the long carrier film as well as adhering the other film of a long material to the long material on the above carrier film to cut into a specified shape. This method, however, involves cutting and taking out a rectangular sheet material in such a way that each of two sides contacted by the rectangle has a specific angle relative to the stretch axis, so the area remaining not cut is inevitably large. This area is directly a loss of an expensive optical film and thus may increase cost. Furthermore, as in JP6-289221A mentioned above, cutting out the elliptically polarizing plate without a joint is extremely difficult when a sheet-like elliptical polarizing plate with a large size is cut out.

As in JP 6-289221 A and JP6-300918A, in the production of an elliptical polarizing plate, a method that involves cutting out one of the optical films at a specific angle in the form of a sheet, and arranging it in a specified position so as to be capable of roll to roll laminating, that is, to be capable of forming in the form of a roll and laminating the longitudinal direction portions to each other may cause a problem in a joint.

On the other hand, a method is also proposed that produces an elliptical polarizing plate without a joint, i.e., a seamless elliptical polarizing plate by means of roll to roll laminating processing. For example, JP55-59407A proposes a method that involves continuously cutting a cylindrically stretched compensation film at a specific angle relative to the stretch direction to obtain a long compensation film, and superimposing and laminating the long compensation film on a stretched, transparent film in the longitudinal direction. This method, however, needs an apparatus for producing a cylindrical film (blow molder), makes it difficult to create an angle with high precision when the cylindrical stretch film is continuously cut at a specific angle, and makes the processes more complicated than the processes in the case of a compensation film fabricated by stretching a rolled film, leading to a considerable increase in cost.

JP2003-248117A describes a method of producing a long elliptical polarizing plate that involves stretching a long cellulose acetate film in a direction neither in parallel nor perpendicular relative to the longitudinal direction to produce a compensation film (phase retarder plate), and then laminating the compensation film to a long, linear polarizing film such that the respective longitudinal directions are in parallel. The method, however, needs to stretch the long cellulose acetate film on the slant. Slant-stretching renders it difficult to stretch at a specific angle with high precision as compared with vertical uniaxial stretch or horizontal uniaxial stretch and thus productivity is low resulting in increasing cost.

Furthermore, each example of JP2004-272202A and JP2004-233872A describes a technique that involves laminating a linear polarizing plate produced by slant-stretching a polyvinyl alcohol film and a compensation film produced by forming an optically anisotropic layer containing a liquid crystalline compound on the transparent support to yield an elliptically polarizing plate. Referring to these techniques, for example, a technique is speculated that involves slant-stretching a rolled polyvinyl alcohol film at a specific angle to produce a rolled linear polarizing plate in which its longitudinal direction is not the stretch direction (i.e., absorption direction), and separately to produce a compensation film in which its longitudinal direction is the slow axis direction, and then roll-to-roll laminating these linear polarizing plate and compensation film in their longitudinal directions to be capable of producing a seamless, rolled elliptically polarizing plate. This method, however, needs to slant-stretch a polyvinyl alcohol film. Slant-stretching makes it difficult to carry out stretching at a specific angle with high precision as compared with vertical uniaxial stretch or horizontal uniaxial stretch, thereby lowering production and increasing cost.

As described above, it is presently difficult to produce an elliptical polarizing plate by means of roll to roll laminating processing in conditions of satisfying all the respects of continuation of the laminating process, improvement of yield, reduction of material loss, and reduction of cost.

### SUMMARY OF THE INVENTION

The present invention has been achieved as a result of studying the solutions of problems in conventional techniques as described above, and an object of the invention is to provide an elliptical polarizing plate that is good in production efficiency and yield and suitable for reducing the thickness of the polarizing plate, and a method of producing the elliptical polarizing plate.

The inventors have diligently studied to develop an elliptical polarizing plate that is good in production efficiency and yield and suitable for reducing the thickness of the polarizing plate and to complete a method of producing the elliptical polarizing plate. In other words, the invention provides a rolled elliptically polarizing plate that is formed by laminating a compensation film having a coated layer produced by a coating agent performing a compensation function on the surface of the rolled linear polarizing plate, the compensation film being a rolled film formed by application of a coating agent performing a compensation function to at least one surface of a translucent substrate, the above linear polarizing plate and the above compensation film being laminated by means of roll to roll processing by making the respective longitudinal directions approximately in parallel, or the above compensation film being formed by application of a coating agent performing a compensation function to the surface of the above rolled linear polarizing plate.

This rolled elliptical polarizing plate is cut in a specific shape to make an elliptical polarizing plate of a sheet material. The elliptical polarizing plate of being a sheet material in this way is applicable to a variety of image display apparatuses. Specifically, its combination with a liquid crystal cell can lead to a liquid display apparatus. Moreover, its combination with organic electric light-emitting means can also result in an organic electric light-emitting display apparatus. Furthermore, its combination with display means and touch input means can also lead to a touch panel. Display means in a touch panel can be a liquid crystal cell or organic electric light-emitting means.

In addition, the invention also provides a method of producing a rolled elliptically polarizing plate that involves laminating a rolled compensation film formed by applying a coating agent performing a compensation function to at least one surface of a translucent substrate and a linear polarizing plate by means of roll to roll processing by making the respective longitudinal directions approximately in parallel.

An elliptically polarizing plate of the invention can be formed in a roll form, and also provides both of a linear polarizing plate and a compensation film, constituting the elliptically polarizing plate, in a seamless form, so the elliptically polarizing plate is good in production efficiency and yield and also suitable for reducing thickness of a variety of display apparatuses, including the case of cutting elliptically polarizing plate to sheet materials.

### BRIEF DESCRIPTION OF THE DRAWINGS

FIG. 1 is a schematic diagram illustrating a rolled elliptically polarizing plate produced by roll-to-roll laminating a rolled quarter-wave plate having the slow axis laid in a 45° direction relative to the longitudinal direction of the rolled film on a rolled linear polarizing plate having the absorption axis direction parallel to the longitudinal direction of the rolled film by making the respective longitudinal directions in parallel;

FIG. 2 is a plain view illustrating a sheet-like quarter-wave plate produced by being cut from a rolled quarter-wave plate fabricated by stretching to a parallelogram; and

FIG. 3 is a schematic diagram illustrating a rolled elliptically polarizing plate fabricated by compactly laminating the sheet-like quarter-wave plate on a rolled linear polarizing plate having the absorption axis parallel to the longitudinal direction of the rolled film.

### DETAILED DESCRIPTION OF THE INVENTION

The invention will be set forth in detail hereinafter. An elliptically polarizing plate defined by the invention is produced by laminating a compensation film having a coated layer produced by a coating agent performing a compensation function on the surface of a rolled linear polarizing plate, the compensation film being a rolled film formed by applying a coating agent performing a compensation function to at least one surface of a translucent substrate, the above linear polarizing plate and the above compensation film being laminated by means of roll to roll processing by making the respective longitudinal directions approximately in parallel, or the above compensation film being a rolled film formed by application of a coating agent performing a compensation function to the surface of the above rolled linear polarizing plate. In addition, the term “elliptically polarizing plate” herein is a concept including a circularly polarizing plate. Moreover, the compensation functions typically include a retardation (phase difference). A retardation a compensation film exhibits is selected, as appropriate, from about 1 to about 3,000 nm, depending on the applications of the elliptical polarizing plate.

A rolled circularly polarizing plate is provided when the absorption axis of the above linear polarizing plate and the slow axis of the above compensation film are substantially crossed at an angle of 45°. At this time, it is preferred that the compensation film is constructed to function as quarter-wave plate. The quarter-wave plate may indicate a retardation of about 90 to about 200 nm of being about quarter-wave relative to any light of the wavelength region (380 to 780 nm) of visible beams.

Actually, the elliptically polarizing plate is frequently handled as a rolled material for production, and when it is applied to a display apparatus, the elliptically polarizing plate is mostly used as a sheet material. In this case, the above rolled elliptical polarizing plate is cut in a specific shape to be capable of obtaining a sheet-like elliptically polarizing plate.

A linear polarizing plate constituting the elliptically polarizing plate is a polarizer having a protective layer laminated thereon, or a polarizer itself. A polarizer has a function that causes linear polarized light from natural light to selectively pass therethrough in a certain direction. For example, the polarizers include an iodine-based polarizing film made by adsorbing iodine to a polyvinyl alcohol film and orienting the absorbed iodines, a dye-based polarizing film made by adsorbing a dichromatic dye to a polyvinyl alcohol film and orienting the absorbed dyes, a coated type polarizer made by coating a dichromatic dye of a lyotropic liquid crystal state and orienting and immobilizing the coated dichromatic dyes, and the like. These iodine-based polarizing and dye-based polarizing films and coated type polarizer cause a certain directed linear polarizer from natural light to selectively pass therethrough, have a function of absorbing another directed linear polarizer, and are called an absorption type polarizer. Poralizers used in the invention may be not only the absorption type polarizer as described above, but a polarizer, called a reflection type polarizer or scatter type polarizer, having a function that causes a certain directed linear polarizer to pass therethrough and reflects or scatters another directed linear polarizer, from natural light. Moreover, poralizers used in the invention are by no means limited to the polarizers specifically described here, but may be polarizers that have a function of causing a certain directed linear polarizer from natural light to selectively pass therethrough. Of these polarizers, absorption type polarizers that are excellent in visibility are preferably used, and of these, an iodine-based polarizer film that is excellent in polarization degree and transmittance is most preferably used as a polarizer.

The iodine-based polarizing film generally has a film made by coating a polyvinyl alcohol resin as a component. This polyvinyl alcohol resin is obtained by saponification of a polyvinyl acetate resin. Illustrative examples of the polyvinyl acetate resins include copolymers of vinyl acetate and another monomer capable of being polymerized therewith in addition to a polyvinyl acetate of being a homopolymer of vinyl acetate. The other monomers that are copolymerized with vinyl acetate include, for example, unsaturated carboxylic acids, olefins, vinyl ethers, unsaturated sulfonic acids, and the like. Degree of saponification of polyvinyl alcohol resin is normally from about 85 to about 100 mol %, preferably 98 mol % or more. This polyvinyl alcohol resin may be modified and, for example, polyvinyl formal or polyvinyl acetal or the like, modified with an aldehyde, is also usable. Moreover, the degree of polymerization of polyvinyl alcohol resin is normally from about 1,000 to 10,000, preferably from about 1,500 to about 5,000.

The method of casting a polyvinyl alcohol resin is not particularly limited, and a known method is applicable. The thickness of a raw fabric film made of a polyvinyl alcohol resin is not particularly limited, and for example is from about 1 μm to about 150 μm.

The polarizing film is normally produced through a step of uniaxially stretching such a polyvinyl alcohol resin film, a process of dyeing the polyvinyl alcohol resin film with a dichromic dye to absorb the dichromic dye, a step of processing the polyvinyl alcohol resin film having the dichromic dye absorbed therein with aqueous boric acid solution, and a process of washing the resulting substance with water after treatment with this aqueous boric acid solution. As a dichromic dye, iodine or a dichromic organic dye is used.

Uniaxial stretching may be carried out prior to dyeing, simultaneously with dyeing, or subsequent to dyeing. When uniaxial stretching is carried out after dyeing, this uniaxial stretching may be carried out prior to boric acid treatment, or during boric acid treatment. Of course, the uniaxial stretching can also be carried out in these plural steps. For uniaxial stretching, the polarizing film may be uniaxially stretched between rolls having different peripheral speeds, or uniaxially stretched by means of a heated roll. In addition, dry stretching of carrying out stretching in the atmosphere, or wet stretching of carrying out stretching in a swollen state by use of a solvent is acceptable. The magnification of stretching is normally from about 4 to about 8 times.

Dyeing of a polyvinyl alcohol resin film with a dichromic dye may involve, for example, immersing the polyvinyl alcohol resin film in an aqueous solution containing the dichromic dye. Additionally, the polyvinyl alcohol resin film may preferably be immersed in water prior to dyeing.

When iodine is used as a dichromic dye, a method is normally adopted that involves immersing a polyvinyl alcohol resin film in an aqueous solution containing iodine and potassium iodine for dyeing. The content of iodine in this aqueous solution is normally from about 0.01 to about 1 weight part based on 100 weight parts of water, and the content of potassium iodide is normally from about 0.5 to about 20 weight parts based on 100 weight parts of water. The temperature of an aqueous solution used in dyeing is normally from about 20 to about 40° C., and the time of immersion (dyeing time) in this aqueous solution is normally from about 20 to 1,800 seconds.

The boric acid treatment subsequent to dyeing with a dichromic dye is carried out by immersion of the dyed polyvinyl alcohol resin film in an aqueous solution containing boric acid. The amount of boric acid in the aqueous solution containing boric acid is normally from about 2 to about 15 weight parts, preferably from about 5 to 12 weight parts, based on 100 weight parts of water. When iodine is used as a dichromic dye, this aqueous solution containing boric acid preferably contains potassium iodide therein. The amount of potassium iodide in the aqueous solution containing boric acid is normally 40 weight parts or less, preferably 30 weight parts or less, based on 100 weight parts of water. The time of immersion in the aqueous solution containing boric acid is normally from about 60 to about 1,200 seconds, preferably from about 150 to about 600 seconds, more preferably from about 200 to about 400 seconds. Additionally, the temperature of the aqueous solution containing boric acid is normally 50° C. or more, preferably from 50 to 85° C.

The polyvinyl alcohol resin film after boric acid treatment is normally water washed. The water washing is carried out, for example, by immersion of the polyvinyl alcohol resin film treated by boric acid in water. A polarizing film is obtained by dry processing after water washing. The temperature of water in the water washing is normally from about 5 to about 40° C., and the time of immersion is normally from about 1 to about 120 seconds. The drying carried out thereafter is normally carried out by means of a hot air dryer or a far infrared heater. The temperature of drying is normally from 40 to 100° C. The time of drying is normally from about 120 to 600 seconds.

In the absorption type polarizer thus obtained (polarizing film), dichromic dyes are oriented along the stretch direction, so the stretching direction is the absorption axis. Therefore, if stretching is carried out by means of vertical uniaxial stretch, the longitudinal direction of the polarizer obtained in a roll shape is the absorption axis.

When the absorption type polarizer described above is used as a material constituting an elliptically polarizing plate, the absorption polarizer is used in a variety of environments, and thus is preferably used as a linear polarizing plate having a transparent protective layer laminated on at least one surface thereof. When a protective layer is disposed only on one surface, the face touching the compensation film may be either on the face side of the transparent protective layer, or on the face without the protective layer. The transparent protective layers include, for example, cellulose resin films of triacetyl cellulose, diacetyl cellulose and the like, acryl resin films, polyester resin films, polyacrylate resin films, polyether sulfone resin films, cyclic polyolef in resin films having as a monomer a cyclic olefin such as norbornene, and the like. The transparent protective layer is not limited to a film-like material. For example, a protective layer formed by coating is acceptable.

In the invention, the linear polarizing plate as mentioned above is constructed in a rolled shape, and has a compensation film having a coated layer made with a coating agent performing a compensation function laminated on the surface thereof. When laminated, this compensation film is a rolled material formed by applying a coating agent performing a compensation function to at least one surface of a transparent substrate, and is formed by laminating a linear polarizing plate and a compensation film by means of roll to roll processing in such a way that the respective longitudinal directions are approximately in parallel, or applying a coating agent performing a compensation function to the surface of a linear polarizing plate.

First, a mode will be described that involves laminating a rolled compensation film formed by applying a coating agent performing a compensation function to at least one surface of a transparent substrate and a rolled linear polarizing plate. The transparent substrate used here is not particularly limited if the transparent substrate can uniformly be applied by a coating agent performing a compensation function, and exhibits a desired compensation function. As a specific transparent substrate, glass and plastic substrates are illustrated, but when a rolled elliptical polarizing plate is produced, a flexible plastic substrate is preferably adopted. The plastic substrates include films made of cellulose resins such as triacetyl cellulose, diacetyl cellulose and the like, acryl resin films, polyester resin films, polyacrylate resin films, polyether sulfone resin films, cyclic polyolefin resin films having as a monomer a cyclic olefin such as norbornene. Additionally, the plastic substrate is not limited to a film-like material and, for example, a transparent layer formed by coating is also acceptable. Moreover, for the adjustment of flexibility of a plastic substrate, to the substrate can be added a glass fiber, a filler, or the like. At this time, the refractive index of an additive is preferably matched to the refractive indexes of surrounding plastics because of increased transparency. Of these, for reducing the thickness of the film, considering that to the polarizer made of the polyvinyl alcohol resin described above is directly laminated the above compensation film by means of an adhesive, a transparent substrate made of a cellulose resin or a cyclic polyolefin resin is most preferable. The thickness of the transparent substrate is normally in the range of about 0.1 to about 1000 μm, preferably in the range of about 1 to about 500 μm, more preferably in the range of about 5 to about 200 μm.

The coating agent performing a compensation function is not particularly limited if the coating agent can be uniformly applied to the above transparent substrate and exhibits a desired compensation function. The coating agents include, for example, a paint prepared by dissolving a rod-like crystalline compound in a solvent and, if required, adding other additives thereto. Examples of the rod-like crystalline compound can include a compound indicated by Formula (I) below.

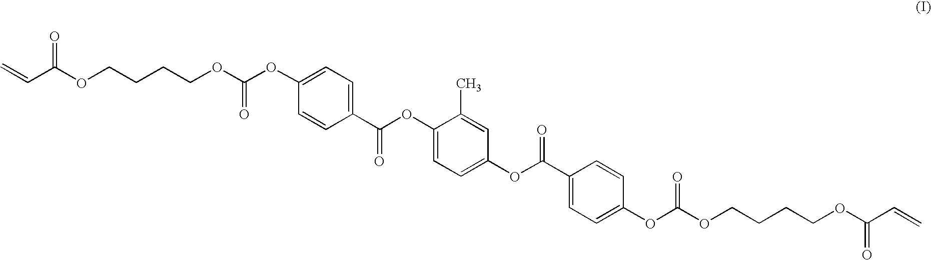

Illustrative examples of the coating agent performing a compensation function include the paint for an optically anisotropic layer containing a rod-like crystalline compound, used in Example 4 of JP2004-272202A and in Example 3 of JP2004-233872A. These Examples use the rod-like crystalline compound of the structure indicated by Formula (I) above. In these Examples, a quarter wave plate (a kind of the compensation film) is produced by applying a paint for an alignment layer containing polyvinyl alcohol to a triacetyl cellulose film subjected to saponification treatment(corresponding to a transparent substrate), subjecting the resulting material to rubbing treatment at a specific angle, applying a coating liquid for an optically anisotropic layer thereto, solidifying, and furthermore rubbing treatment the surface at another specific angle, applying a paint for an optically anisotropic layer different from the above thereto, and then solidifying. In this case, carrying out rubbing treatment at a desired angle relative to the longitudinal direction of the film, the rolled linear polarizing plate and the rolled compensation film can be laminated by means of roll to roll processing in such a way that the respective longitudinal directions are approximately in parallel to produce a rolled circularly polarizing plate (a kind of the elliptical polarizing plate). In this way, an approach of being capable of producing a rolled elliptical polarizing plate without a joint only by changing the direction of rubbing has an advantage of using a compensation film formed by applying a coating agent performing a compensation function to a transparent substrate. This approach is technically easy and thus high in productivity as compared with the method that involves matching the absorption axis of a polarizer and the slow axis of a compensation film to a desired angle by slant stretching.

Additionally, although a compensation film fabricated by stretching of a film, widely used in this field presently, is at best as thin as about 40 μm, a compensation film fabricated by applying a coating agent performing an orientation function to a transparent substrate as mentioned above can have a desired compensation function only with a coated layer by, as appropriate, selecting a coating agent. The thickness of this layer can be made as thin as to about a few μm.

In an illustrative example of the coating agent performing the above compensation function, the methods of regulating the orientation of a rod-like crystalline compound have included a method of rubbing treatment an alignment layer (rubbing orienting method). Although this method is suitable, if the method of orientating a liquid crystalline compound exhibits a desired compensation function, the method is not limited. The methods of orienting a liquid crystalline compound include, other than the rubbing orienting method, include a rhombic deposition method for an inorganic compound, a rhombic irradiation method for an ion or the like, a method of forming a layer having a micro group, a method of forming a Langmuir-Blodgett film (LB film), a method of generating orientation function by irradiating light to an alignment layer, a method of generating orientation function by imparting an electric field or magnetic field to an alignment layer, and the like.

A compensation film formed by applying a coating agent performing a compensation function to a transparent substrate is preferably divination glued in order for a face laminated on a linear polarizing plate to be well adhered to the linear polarizing plate. This is because when an elliptically polarizing plate is applied to an image display apparatus to be described below, the environments using the image display apparatus are various, so the material that is readily delaminated between layers is not preferred for use. For example, a liquid crystal display apparatus used in a car navigation system is always put within a car. Thus, when it is hot weather like summer or the like, the temperature within a car is as high as 70° C. or higher. Hence, an elliptically polarizing plate is needed that endures even such an environment. The methods of divination gluing treatment that may be performed as appropriate include surface treatment such as plasma treatment, corona treatment, ultraviolet-ray irradiation treatment, flame (fire) treatment, saponification treatment or the like. The saponification treatment includes a method that involves immersing the material in an aqueous alkaline solution of sodium hydroxide, potassium hydroxide or the like. When a cellulose resin is used as a transparent substrate of a compensation film, saponification treatment is generally and frequently used; when a cyclic olefin resin is used, corona treatment is generally and frequently used.

As a method of laminating a compensation film and a linear polarizing plate, a method of laminating the both through an adhesive is preferably adopted, since a preferable adhesion can be attained.

When the both are laminated through an adhesive, any adhesive may be used if the adhesive is excellent in adhesion and does not have an adverse effect on the optical properties of an elliptically polarizing plate. Specifically, the adhesives that are used for lamination include adhesives such as a water-based adhesive, an organic solvent adhesive, a hot-melt adhesive, an inorganic solvent adhesive and the like. The adhesives, when listed based on materials, include monomer/oligomer adhesives of methacrylate, oxetane and the like, resin adhesives of urine resin, melamine resin, phenol resin, resorcinol resin, epoxy resin, urethane resin, vinyl acetate resin, polyvinyl alcohol resin, acrylic resin, cellulose resin and the like, rubber adhesives such as chloroprene, nitrile rubber, styrene butadiene rubber, styrene block copolymer thermoplastic elastomer, butyl rubber, natural rubber, recycled rubber, chlorinated rubber, silicone rubber, and the like, and natural adhesives of glia, starch and the like. More specifically, the water-based adhesives include, for example, an aqueous solution of polyvinyl alcohol resin, a waterborne two-part urethane emulsion adhesive using urethane resin, and the like; the organic solvent adhesives include, for example, a two-part urethane adhesive using urethane resin, and the like; and the inorganic solvent adhesives include, for example, one-part urethane adhesive using urethane resin, and the like.

When a transparent substrate constituting a compensation film is comprised of a cellulose resin and the laminated face is divination glued, while the laminated face of a linear polarizing plate is a polarizer comprised of polyvinyl alcohol resin, an aqueous solution of polyvinyl alcohol resin is suitably used as an adhesive. The polyvinyl alcohol resins used as an adhesive include, in addition to vinyl alcohol homopolymer obtained by saponifying polyvinyl acetate, i.e., a homopolymer of vinyl acetate, a vinyl alcohol copolymer obtained by saponifying copolymers of vinyl acetate and other monomers capable of copolymerizing with vinyl acetate, modified polyvinyl alcohol polymers partially modifying the hydroxyl groups thereof, and the like. For this adhesive may be used polyaldehyde, a water-soluble epoxy compound, a melamine compound, or the like as an additive.

The methods of applying an adhesive are not limited and include, for example, a method that involves uniformly applying an adhesive to the surface of a compensation film or linear polarizing plate, superimposing another film on the applied face, and then laminating by means of a roll, and the like. The temperature of application is normally at 15 to 40° C., and the temperature of lamination is normally in the range of about 15 to about 30° C.

The adhesive is cured by carrying out heating, irradiation of activation energy beams, or both, and thus can strongly adhere a compensation film to a linear polarizing plate.

When cure is carried out by heating, there are cases where a reaction monomer is polymerized to cure and where a solvent contained in an adhesive is dried and removed to solidify. Both cases can use heating by a generally known method, and the conditions and the like also are not particularly limited, but heating at a high temperature leads to the degradation of a linear polarizing plate, and therefore the heating is normally preferably carried out at 20 to 120° C.

For cure by drying, the temperature of drying an adhesive is normally from about 30 to 85° C., preferably from about 40 to 80° C. Thereafter, the adhesive may be aged at about 15 to 85° C., preferably at about 20 to 50° C., more preferably at about 35 to 45° C. normally for about 1 to about 90 days to solidify. When this aging time is long, the productivity is low, and therefore the aging time is preferably from about 1 to about 30 days, more preferably from about 1 to 7 days.

For solidification by irradiation of activation energy beams, a source to be used is not particularly limited, and for example a low-pressure mercury lamp, a medium-pressure mercury lamp, a high-pressure mercury lamp, a super high-pressure mercury lamp, a metal halide lamp, or the like can be used. The strength of photoirradiation also is not particularly limited, and the strength of the irradiation peak at the absorption wavelength of photo initiator included in the adhesive is preferably from 10 to 10,000 mW/cm². When the strength of photoirradiation is less than 10 mW/cm², the reaction time is too long; when the strength exceeds 10,000 mW/cm², the degradation of the linear polarizing plate can be generated due to radiation heat from the lamp. The photo irradiation time also is not particularly limited, and the addition light intensity indicated by the product of radiation intensity and irradiation time is preferably set to be from 10 to 10,000 mj/cm². When the addition light intensity is less than 10 mj/cm², the solidification of the additive cannot sufficiently proceed, while when the addition light intensity exceeds 10,000 mj/cm², the degradation of the linear polarizing plate can be generated.

Even when the adhesive is cured either heating or activation energy beam radiation, it is preferably cured within the range of not lowering a variety of functions of the linear polarizing plate such as polarization degree, transmittance, and color.

In addition, the adhesion of a compensation film and a linear polarizing plate can make use of a pressure sensitive adhesive. The pressure sensitive adhesive is a kind of adhesive also called a sticker. The examples include (meth)acrylate, oxcetane, styrene butadiene rubber, butyl rubber, natural rubber, silicone rubber, polyisoprene, polybutene, polyvinyl ether, acrylic resin, polyester, and the like. Of these, adhesives or stickers of (meth)acrylate, oxcetane, acrylic resin, polyester, epoxy, polyurethane resins are preferred. These adhesives or stickers are preferable also because of being high in transparency and good in weather resistance. Further, when a thin linear polarizing plate is used, adhesives of (meth)acrylate, acryl resin, and polyester are particularly preferably used.

When a pressure sensitive adhesive is used, it can be aged at about 15 to 85° C., preferably at about 20 to 50° C., more preferably at about 35 to 45° C. normally for about 1 to about 90 days after lamination to improve adhesion. When this aging period of time is long, the productivity is worsened, and thus the aging time period is preferably for about 1 to about 30 days, more preferably for about 1 to 7 days.

Next, a mode will be set forth that involves applying a coating agent performing a compensation function to form a compensation film on a linear polarizing plate. In the description so far, a compensation film is formed by application of a coating agent performing a compensation function to a transparent substrate. The mode can be achieved by replacing this transparent substrate by a rolled linear polarizing plate previously explained. Hence, this mode may involve simply applying a coating agent performing a compensation function described above to the surface of a rolled linear polarizing plate, and thus a further detailed description is omitted.

As in the above, an elliptically polarizing plate of the invention is obtained in the form of a roll; the elliptically polarizing plate is made by laminating a compensation film having a coating layer coated with a coating agent performing a compensation function to the surface of a rolled linear polarizing plate. Then, when a rolled material having a dichromic dye comprised of iodine or a dichromic dye adsorbed and orientated thereon is used for a stretch film of polyvinyl alcohol resin presently widely used as a linear polarizing plate, its longitudinal direction is the absorption axis. The invention is particularly useful for this mode. An elliptically polarizing plate obtained in the form of a roll can be made to be a sheet material by cutting it in a specified shape in order to be applied to an image display apparatus to be described below and the like.

In addition, a rolled elliptically polarizing plate can be produced also by a method that involves applying a paint to a rolled compensation film formed by applying a coating agent performing a compensation function to at least a single face of a transparent substrate. In the case of this method, an application type polarizer is used as a paint providing polarization performance. Application in this case can usually be carried out by means of a general method. The general methods that are used include, for example, various coating methods such as Meyer bar coating, gravure coating, die coating, dip coating, spray coating, roll coating, comma coating, knife coating and the like, and printing techniques such as a screen printing process and an ink jet printing process. In particular, a coating method is preferred that provides a shearing stress. When a paint providing polarization performance is a solution or a solution having a coating agent dispersed therein, a polarizing layer can be formed by evaporating the solvent after coating. The method of evaporating the solvent can be a conventional drying method. For example, methods can be adopted that include heat drying, room-temperature drying, freeze drying, far infrared-ray drying, and the like. The thickness of a polarizing layer thus obtained can be made to be as thin as from about 20 to abut 1,500 nm. This thickness is preferably 50 nm or more, and preferably 1,000 nm or less, as appropriate, selected depending on the transmittance of a linear polarizing plate obtained.

An elliptically polarizing plate of the invention can be utilized as an anti-reflection layer in a variety of optical products or image display apparatuses or the like. For an anti-reflection layer is generally said to be used a circularly polarizing plate. However, a circular polarizing plate is sometimes used by slightly shifting circular polarizing to elliptically polarizing in order to adjust visibility such as color, contrast or the like of optical products or image display apparatuses.

Preferred illustrative examples of the image display apparatus to which an elliptically polarizing plate of the invention is applied can include a reflection type liquid crystal display apparatus (including a transflective type liquid crystal display apparatus), a display apparatus using organic electric light-emitting, a touch panel, and the like.

A liquid crystal display apparatus primarily comprises a liquid crystal cell having a liquid crystal inserted in between two substrates having an electrode; display is carried out by the presence or absence of the application of a voltage thereto, the strength of the application voltage, or the like. On its visibility side is disposed an elliptically polarizing plate.

An organic electric light-emitting (organic EL) display apparatus is a display apparatus that uses organic electric light-emitting means that involves causing a compound containing therein an organic compound to receive energy from an electric field and to be excited and to re-emit the energy as the form of light. Specifically, the apparatus is comprised of substrate/transparent electrode (anode)/hole transport layer/light-emitting layer/electron transport layer/transparent electrode (cathode) /substrate, and involves rendering a hole injected from the anode and an electron injected from the cathode to reach the light-emitting layer respectively through the hole transport layer and the electron transport layer, to re-combine there, and rendering the organic molecule to light-emit through its excited state. An elliptically polarizing plate is disposed on the substrate of its visibility side.

A touch panel has display means and touch type input means as constituents. Examples of the display means include a cathode ray tube (CRT), a plasma display panel (PDP), a field emission display (FED), an inorganic electric field light-emitting display apparatus, an organic electric field light-emitting display apparatus, a liquid crystal display apparatus, and the like. Touch type input means generally has a structure like conductive film/spacer/conductive film; an elliptical polarizing plate is disposed on the conductive membrane of its visibility side. The touch panels are classified into a resistance film type touch panel, an optical touch panel, a supersonic touch panel, a capacitance touch panel, and the like, according to the classification based on detection systems. An elliptically polarizing plate of the invention can be applied to any touch panel systems.

### EXAMPLES

The invention will be described more specifically by indicating Examples hereinafter, but the invention is by no means limited to these Examples. In the Examples, “parts” indicating the amount of use is by weight unless otherwise indicated. In addition, the measurement and evaluation of physical properties are carried out in accordance with the following methods.

(1) Single Transmittance and Degree of Polarization of Linear Polarizing Plate Portion

The polarization performance of the polarizing portion of an elliptically polarizing plate is determined using a spectrophotometer “UV-2450” available from Shimadzu Corporation in accordance with SEMI Standard “SEMI D34-0703 Method of Measuring FPD Polarizing Plates,” the copyright of which Semiconductor Equipment and Materials International (SEMI Japan) has. At the time of the measurement, a sample was set for a polarizing plate in which the linear polarizing plate had a compensation film fitted therewith in such a way that the light emitted from the source of the spectrophotometer proceeded in the order of the polarizing prism of the spectrophotometer/linear polarizing plate/compensation film/light receiver, so as not to undergo the influence of the compensation film.

(2) Ellipticity

The ellipticity of an elliptically polarizing plate was determined at a wavelength of 545.7 nm using an automatic birefregence analyzer “KOBRA-21ADH” available from Oji Scientific Instruments. The ellipticity refers to the ratio minor axis/major axis of an ellipsoid constituting elliptical polarization. The elliptical polarization is so called because of the shape of the trajectory of a light wave observed from the propagation direction of light. Specifically, the ellipticity is 1 for circular polarization, 0 for linear polarization, and from 0 to 1, both exclusive, for elliptical polarization.

(3) Taking Out Efficiency

When e sheets of joint-free, sheet-like elliptically polarizing plates having a length of c mm and a width of d mm are taken out of a rolled elliptically polarizing plate having an effective width of a mm and an effective length of b mm, the value R calculated from Equation (1) below is defined as the taking out efficiency of an elliptically polarizing plate. The larger the taking out efficiency R, the better the yield.
R=cde/ab×100 (%) (1)

### Example 1

(a) Rolled Quater-Wave Plate

A rolled Quater-Wave plate was prepared that has a slow axis in the direction inclined at an angle of 45° within a film face relative to the longitudinal direction of a rolled transparent substrate, with polymerizing liquid crystal compounds being orientated along a single face of the rolled substrate produced by saponifying a triacetyl cellulose film having a thickness of 80 μm (“Fujitac TF80UL” available from Fuji Photo Film Co., Ltd.) by making use of a photo alignment layer.

(b) Rolled Linear Polarizing Film

A rolled polyvinyl alcohol film having a thickness of 75 μm, an average polymerization degree of about 2,400, and a saponification degree of 99.9 mol % or more was uniaxially stretched with dry process at a stretching magnification of 5-fold, and then immersed in an aqueous solution of iodine/potassium iodide/water in a weight ratio of 0.05/5/100 at 28° C. for 60 seconds while keeping the strain. Then, the resulting film was immersed in an aqueous solution of potassium iodide/boric acid/water in a weight ratio of 10/9.5/100 at 74° C. for 300 seconds. The film was washed with purified water at 26° C. for 20 seconds, and then dried at 65° C. to obtain a rolled linear polarizing film of the polyvinyl alcohol having iodine adsorption orientated thereon. The thickness was about 26 μm. At this time, the absorption axis of the polarizing film was laid in parallel to the longitudinal direction of the rolled film.

(c) Fabrication of Rolled Elliptically Polarizing Plate

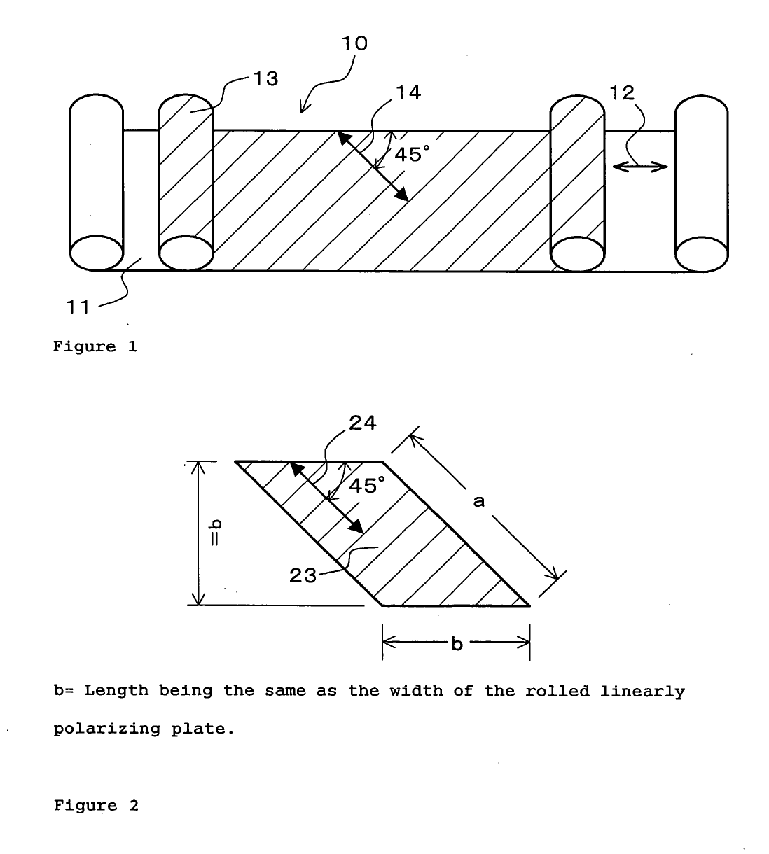

4 Parts of polyvinyl alcohol having an average polymerization degree of about 1,700, and a saponification degree of 99.6 mol % or more was dissolved in 100 parts of water to prepare a polyvinyl alcohol adhesive. To both faces of the rolled polarizing film obtained previously was applied this adhesive, and then to a single face of the polarizing film was laminated a material produced by saponifying a triacetyl cellulose film having a thickness of 80 μm (“Fujitac TF80UL” obtained from Fuji Photo Film Co., Ltd.) such that the respective longitudinal directions are the same, with the other face of the polarizing film being the triacetyl cellulose film side in the rolled Quater-Wave plate. At this time, the angle which the absorption axis of the linear polarizing plate forms the slow axis of the Quater-Wave plate is 45°. Thereafter, the resulting plate was dried at 65° C. to obtain a rolled elliptically polarizing plate 10 having a structure indicated as a schematic diagram in FIG. 1. In other words, this elliptically polarizing plate 10 has a rolled linear polarizing plate 11 formed on a single face of the rolled polarizer by means of roll to roll laminating processing of a rolled transparent protective layer and also has a rolled compensation film 13 roll-to-roll laminated on the face on which the transparent protective layer is not laminated. The absorption axis 12 of the linear polarizing plate 11 is laid in the longitudinal direction of the elliptically polarizing plate 10; the slow axis 14 of the compensation film 13 is laid at 45° with respect to the longitudinal direction of the elliptically polarizing plate 10.

(d) Evaluation of Polarization Performance

The rolled elliptically polarizing plate 10 thus obtained was smooth without a joint as shown in FIG. 1. The thickness of this elliptically polarizing plate was 190 μm. The single unit transmissivity and the degree of polarization of the linear polarizing plate portion were determined to be 42.7% and 100.0%, respectively. Additionally, the ellipticity was 0.94, which substantially meant an elliptically polarizing plate.

### Example 2

When sheet-like elliptically polarizing plates (length 100 mm×width 50 mm) were cut from the rolled elliptically polarizing plate (width 100 mm×length 5 m, the longitudinal direction and the absorption axis of the linear polarizing plate are laid in parallel) obtained in Example 1 in such a way that the length direction was laid in the absorption axis of the linear polarizing plate, 100 sheets of elliptically polarizing plates without joints were capable of being cut out. In this example, the taking out efficiency R calculated by Equation (1) above was 100%.

### Example 3

When sheet-like elliptically polarizing plates (length 50 mm×width 50 mm) were cut from the rolled elliptically polarizing plate (width 100 mm×length 5 m, the longitudinal direction and the absorption axis of the linear polarizing plate are laid in parallel) obtained in Example 1 in such a way that the length direction was laid in the absorption axis of the linear polarizing plate, 200 sheets of elliptically polarizing plates without joints were capable of being cut out. In this example as well, the taking out efficiency R calculated by Equation (1) above was 100%.

### Comparative Example 1

In this example, an elliptically polarizing plate was fabricated by stretching of a resin film; the method of fabrication involves cutting a compensation film having the slow axis in the longitudinal direction thereof to a sheet-like film at a specified angle, and laminating it to a rolled linear polarizing plate having the absorption axis direction in the longitudinal direction thereof via a pressure sensitive adhesive at a specified angle.

(a) Fabrication of Rolled Linear Polarizing Plate

A rolled linear polarizing film was fabricated as in (b) of Example 1. Thereafter, a polyvinyl alcohol adhesive the composition of which is the same as that of the adhesive used in (c) of Example 1 was applied to the both face of the rolled linear polarizing film. Then, a rolled triacetyl cellulose film “Fujitac TF80UL” having a thickness of 80 μm that is the same as that of the film used in (c) of Example 1 was saponificated. This saponificated film was laminated on the respective faces of the polarizing film by means of roll to roll processing. Subsequently, the resulting laminate was dried at 70° C. to obtain a rolled linear polarizing plate. The thickness of this linear polarizing plate was 188 μm.

(b) Fabrication of Elliptically Polarizing Plate

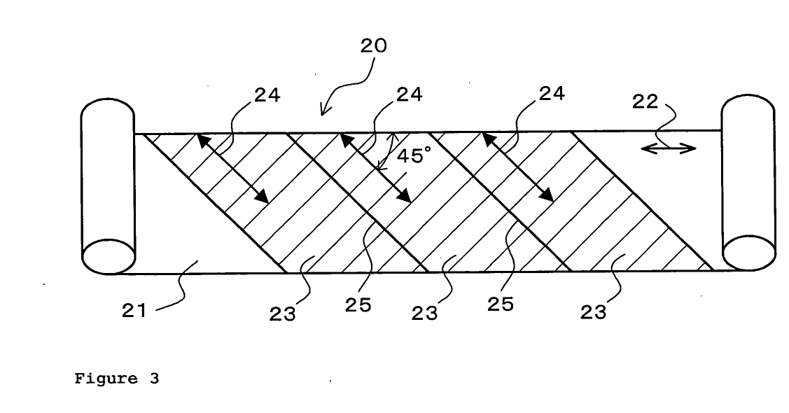

As shown in a plain view of FIG. 2, a Quater-Wave plate 23 cut to a sheet-like parallelogram (“sumikalight” obtained from Sumitomo Chemical Co., Ltd., thickness: about 50 μm) was selected as a compensation film. This Quater-Wave plate 23 has a side a in the slow axis 24 and an another side b crossed at an angle of 45°, and is a plate cut to a parallelogram in which the distance (height) between the two parallel sides b, b is the same as the width of the previous rolled linear polarizing plate, in order to be laminated to the above rolled linear polarizing plate. In addition, the length of the side b is the same as the width of the rolled linear polarizing plate. This compensation film (Quater-Wave plate 23) is continuously and compactly laminated on the previous rolled linear polarizing plate through a transparent pressure sensitive adhesive layer having a thickness of 25 μm such that the angle which the absorption axis of the linear polarizing plate forms the slow axis of the Quater-Wave plate is 45°, thereby obtaining a rolled elliptically polarizing plate as indicated by a schematic diagram in FIG. 3. That is, this rolled elliptically polarizing plate 20 is made by compactly laminating the sheet-like Quater-Wave plate 23 on the rolled linear polarizing plate 21, with the absorption axis 22 of the linear polarizing plate 21 being laid in the longitudinal direction of the elliptically polarizing plate 20 and the slow axis 24 of the Quater-Wave plate 23 being laid at an angle of 45° with respect to the longitudinal direction of the elliptically polarizing plate 10.

(c) Evaluation of Polarization Performance

The rolled elliptically polarizing plate thus obtained, as shown in FIG. 3, had joints 25 appearing at a pitch that is the same as the length equal to the width of the rolled elliptically polarizing plate. The thickness of this elliptically polarizing plate was 263 μm. The single transmittance and the degree of polarization of the linear polarizing plate portion were determined to be 43.0% and 100.0%, respectively. Additionally, the ellipticity was 0.95, which substantially meant an elliptically polarizing plate.

### Comparative Example 2

When sheet-like elliptically polarizing plates (length 100 mm×width 50 mm) were attempted to be cut from the rolled elliptically polarizing plate (width 100 mm×length 5 m, the longitudinal direction and the absorption axis of the linear polarizing plate are laid in parallel) obtained in Comparative Example 1 in such a way that the length direction was laid in the absorption axis of the linear polarizing plate, elliptically polarizing plates without joints were not capable of being cut out. Hence, in this example, the taking out efficiency R calculated by Equation (1) above was 0%.

### Comparative Example 3

When sheet-like elliptically polarizing plates (length 50 mm×width 50 mm) were cut from the rolled elliptically polarizing plate (width 100 mm×length 5 m, the longitudinal direction and the absorption axis of the linear polarizing plate are laid in parallel) obtained in Comparative Example 1 in such a way that the length direction was laid in the absorption axis of the linear polarizing plate, 100 sheets of elliptically polarizing plates without joints were capable of being cut out. Hence, in this example, the taking out efficiency R calculated by Equation (1) above was 50%.

The results of the above Examples and Comparative Examples were summarized in Tables 1 and 2 below.

TABLE 1

Performance of linear
polarizing plate portion

| | Single | Degree of | |
|---|---|---|---|
| Example No. | transmittance | polarization | Ellipticity |
| Example 1 | 42.7% | 100.0% | 0.94 |
| Comparative | 43.0% | 100.0% | 0.95 |
| Example 1 | | | |

TABLE 2

| Example No. | Taking out efficiency |
|---|---|
| Example 2 | 100% |
| Example 3 | 100% |
| Comparative Example 2 | 0% |
| Comparative Example 3 | 50% |

What is claimed is:

1. A rolled elliptically polarizing plate formed by laminating a compensation film having a coated layer produced by a coating agent performing a compensation function on the surface of the rolled linear polarizing plate, the compensation film being a rolled film formed by application of a coating agent performing a compensation function to at least one surface of a transparent substrate, wherein
the linear polarizing plate and the compensation film are laminated by means of roll to roll processing by making the respective longitudinal directions approximately in parallel, or
the compensation film is formed by application of a coating agent performing a compensation function to the surface of the linear polarizing plate.

2. The rolled elliptically polarizing plate of claim 1, wherein
the slow axis of the compensation film and the absorption axis of the linear polarizing plate are crossed substantially at an angle of 45°.

3. The rolled elliptically polarizing plate of claim 2, wherein
the compensation film functions as a Quater-Wave plate.

4. The rolled elliptically polarizing plate of any one of claims 1 to 3, wherein
the linear polarizing plate comprises an absorption type polarizer.

5. The rolled elliptically polarizing plate of any one of claims 1 to 3, wherein
a transparent protective layer is laminated on at least one surface of the absorption type polarizer constituting the linear polarizing plate.

6. The rolled elliptically polarizing plate of any one of claims 1 to 3, wherein
the compensation film being a rolled film formed by application of a coating agent performing a compensation function to at least one surface of the transparent and
the polarizing plate and the compensation film are laminated by means of roll to roll process by making the respective longitudinal directions approximately in parallel.

7. The rolled elliptically polarizing plate of claim 6, wherein
the transparent substrate includes a cellulose resin or cyclic polyolefin resin.

8. The rolled elliptically polarizing plate of claim 6, wherein
the face laminated to the linear polarizing plate of the compensation film is subjected to divination gluing processing.

9. The rolled elliptically polarizing plate of any one of claims 6, wherein
the compensation film and the linear polarizing plate are laminated by means of an adhesive.

10. The rolled elliptically polarizing plate of any one of claims 1, wherein
the longitudinal direction of the linear polarizing plate is laid in the absorption axis.

11. The rolled elliptically polarizing plate, wherein
the rolled elliptically polarizing plate of any one of claims 1 is cut in a specified shape to a sheet-like material.

12. A liquid crystal display apparatus comprising the elliptically polarizing plate of claim 11 and a liquid crystal cell.

13. An organic electric light-emitting display apparatus comprising the elliptically polarizing plate of claim 11 and organic electric light-emitting means.

14. A touch panel comprising the elliptically polarizing plate of claim 11, display means, and touch input means.

15. A method of producing a rolled elliptically polarizing plate, wherein
the compensation film formed by application of a coating agent performing a compensation function to at least one surface of the transparent substrate and a rolled linear polarizing plate are laminated by means of roll to roll processing by making the respective longitudinal directions approximately in parallel.

16. The method of claim 15, wherein
the slow axis of the compensation film and the absorption axis of the linear polarizing plate are laminated so as to be crossed substantially at an angle of 45°.

17. A method of producing an elliptically polarizing plate, wherein
the rolled elliptically polarizing plate obtained by the method of claim 15 or 16 is cut in a specified shape to a sheet-like material.
